(19) United States
(12) Patent Application Publication
(10) Pub. No.: US 2007/0174042 A1
(43) Pub. Date: Jul. 26, 2007

(54) Electronic tour guide system

(76) Inventor: Sidney S. Thompson, Washington, DC (US)

Correspondence Address: Leslie A. Thompson;Suite 600, 1717 K Street, NW, Washington, DC, 20036, US

(21) Appl. No.: 11/657,069

(22) Filed: Jan. 24, 2007

Related U.S. Application Data
(60) Provisional application No. 60/761,042, filed on Jan. 24, 2006.

(51) Int. Cl. G06F 17/28

(52) U.S. Cl. 704/3

(57) ABSTRACT

A method and system of an electronic tour guide system having intelligent software that employs the Internet to engage a proprietary database that provides tourists and business travelers with access to useful tourist information related to historic landmarks, hotels, restaurants, tourist attractions, entertainment and sports venues, special events, cultural norms and other information related to foreign city they plan to visit. Moreover, the system features a language learning system to further enhance a user's experience in a foreign locale by offering survival level indoctrination and native level immersion of foreign language.

### REFERENCE TO RELATED APPLICATION

This application claims priority to U.S. Provisional Application Ser. No. 60/761,042 filed Jan. 24, 2006, the entire content of which is incorporated herein by reference.

### BACKGROUND OF THE INVENTION

### Field of the Invention

The present invention relates to a tour guide system that is predicated on a proprietary database accessible through the Internet. More specifically, the present invention is an Internet-based system designed to assist tourists and business people plan excursions, view city attractions, see short commercial video segments on tourism-related information, become more familiar with the cultural norms and business etiquette of a city, learn the language, (of the preferred embodiment, Chinese) and develop an overall psychologically comfortable feel for an anticipated excursions.

As the World's political environment, business relationships, economic reliance, cultural, educational and technological relationships continue to link various cultures, the ease of communication, travel and familiarity with other cultures is paramount. As global relationships develop and become more interdependent, there is a continuing need and opportunity for tourists and business travelers to interact in various cultural settings. It has been reported that international business travel and tourism has been on a steady rise over the last two decades. For the business traveler, the rise in travel can be attributed to an expansion of global business, economic relations and cross-cultural interchange and interaction. Tourists embrace the world with a desire of curiosity—wanting to gain more than a surface experience and exposure to particular cultures. Increasingly, tourists want to experience more than tourist attractions, they also strive to develop an appreciation for the people and culture of foreign lands. The business traveler wants to attain and remain viable in the global business arena by learning as much as possible about the other cultures and business norms.

Even though this is the goal of many travelers, they often times feel isolated and detached when traveling in a foreign country. They develop psychological uneasiness—primarily because they are unable to communicate effectively and they are exposed to unfamiliar surroundings. The psychological uneasiness is caused by a fear of the unknown and categorized as “culture shock.” Other contributing factors may include the possibility of getting lost, inability to read street signs, inability to ask for directions or to read and write in certain situations. Hence, a general overwhelming sense of not being in control may develop. In this situation, fear overwhelms one's true nature and in all likelihood, the trip may not be an enjoyable trip for the tourist or businessperson.

Travel studies suggest and experts advise that the best way to overcoming the “culture shock” is to prepare in advance for a trip by creating an itinerary, becoming familiar with the language and currency, and learning some of the cultural norms, etiquette and history. Studies have shown that tourists that follow this advice—simply overcome the aforementioned psychological uneasiness and their excursions tend to be much more pleasurable.

The present invention is an electronic tour guide system that engages an Internet-based proprietary database component to help tourists and business travelers access travel information related to historic landmarks, hotels, restaurants, entertainment and sports venues, embassies, medical facilities, governmental agencies, major business and trade centers, cultural norms and other information related to selected foreign cities that have are features of the proprietary database.

The present invention can be used by tourists and business people to access necessary information before and during their visits to foreign cities available in the proprietary database. The present invention will allow the user to preplan the trip, get familiar with the cities on their itinerary, and download certain information into a home computer, laptop, MP-4 video player and/or a person digital assistant (“PDA”), so that it can be readily accessed during the trip. The preferred embodiment of the invention will focus on tourist and business information for five major cities in China—Beijing, Shanghai, Hong Kong, Xian and Guilin. The present invention also offers a language learning component that allows the user to learn how to speak, read and write Mandarin Chinese (of the preferred embodiment) vocabulary and sentence structures that will facilitate improved communication during their travel. The language learning system has interactive, voice-enhanced, and visual methods of teaching the Mandarin Chinese language.

Accordingly, a need exists for a tour guide system that provides tourists and business travelers an opportunity to preplan their trip and become familiar with historic landmarks, hotels, restaurants, tourist attractions, entertainment and sports venues, special events, language, cultural norms and other information useful to international tourists. Additionally, a need exists for a tour guide system having a language learning system that instructs a user on how to speak, read, and write a foreign language, such the Mandarin Chinese language in the preferred embodiment of the invention. The need exists for a system that exposes the tourist and business traveler to resourceful information and helps them develop a psychological level of comfort with the anticipated trip.

### SUMMARY OF THE INVENTION

The present invention provides an Internet-based proprietary database that supports a digital travel guide offering tourist information including, but not limited to, historic landmarks, hotels, restaurants, tourist attractions, entertainment and sports venues, cultural norms, and other information related to a foreign city that has a profile stored within the system. Moreover, the present invention provides a language learning system that allows users to speak, comprehend, read and write important vocabulary, phrases and sentence structure, respectively, to facilitate communication while traveling in a foreign country like China. The tour guide system further incorporates, along with the Internet component, additional downloads, map books, video advertisements, and other information that can be viewed from a personal computer (“PC”), laptop or downloaded into a PDA.

The present invention is comprised of various components that integrate to define the tour guide system. The main components of the electronic tour guide system include an Internet database and software application that will allow users to access the components of the system—namely city views and the language learning system. The preferred embodiment will focus on the country of China and a plurality of cities therein—namely Beijing, Shanghai, Hong Kong, Xian and Guilin. The present invention is also accessible via codes embedded in a compact disk (“CD”) that accompanies a map book covering the five cities of the preferred embodiment that focus on the country of China. Using the CD will allow the user to connect with the Internet proprietary database via the tour guide system. The tour guide system provides tourist information that is easily accessible on a home computer, or laptop. Subsequently, information from the tour guide system can be downloaded into a PDA. The wireless technology of most PDAs will allow a tourist to access the Internet proprietary databases for information and periodic updates, even during a trip.

### WEB ACCESS

Once the user accesses the proprietary database program via the Internet, they are brought to the home page of the service provider. On the homepage of the service provider, a user can access advertisers of businesses located in the cities featured in the city views, view and purchase product related products, access frequently asked questions (FAQs), learn about the service provider, email the service provider, seek tech support, and purchase system packages from the product line.

Upon entering the website, the user is shown an introductory video about the tour guide system, city views for a selected city, and a language learning system. The user can choose among other tasks to proceed to the Product Line. Selecting the Product Line, the user can choose 1) one of the city view packages and/or 2) the language learning system, which teaches Mandarin Chinese in the preferred embodiment.

### VIRTUE: THE TOUR GUIDE

The user can choose the tour guide with city views and Chinese Language Learning system. The user can choose the entire program or the user can select components of the system. For example, the user can see only one of the city views or they can select all the city views offered. For the preferred embodiment, the user has access to select city views for the cities of Beijing, Shang Hai, Hong Kong, Xian and Guilin in the country of China. Based on the user's choices, fees are associated with the number of city views selected. The Virtue Chinese language learning system can be added to fees associated with the city views the user selected.

If the user only chooses to access one city through city views, they will be able to view historic landmarks, hotels, restaurants, tourist attractions, entertainment and sports venues, cultural norms, embassies, medical facilities, government agencies, business and trade centers, and other information of interest to tourists. If the user accesses multiple city views, they are afforded two additional features; the ability to plan their trip in advance and updates related to special events.

When the user accesses city views, an overview visual tour is available for each city with available city views. The visual tour will include the most popular tourist attractions and historic sites, for example in Beijing—the visual tour will include Tiananmen Square, the Temple of Heaven and the Great Wall of China. The virtual tours will also include historic information, famous Chinese personalities, and other relevant information available in the system database.

### BUSINESS ADVERTISERS

The tour guide system will provide the user with tourist information, including hotels, restaurants, entertainment, sports and special events venues, shopping arenas, music and theater establishments, embassies, medical facilities, tourist and historic sites. The businesses among these categories will pay to advertise with the service provider. The businesses will provide a business profile and that information will be made available to the user of the present invention. Specific information made available from the advertising businesses for the user can include but not limited to the businesses' address, prices, amenities, available services and video clips of the facilities. If the businesses offer specialty items, like a merchant that sells an extraordinary quality silk or specialty Chinese cuisine, this information will also be available to the user.

### MAP BOOK

The tour guide system features a hard cover map book that can be purchased in bookstores or other retail outlets. The map book features city-specific maps with informative overlays for each city. The map of the city is divided up into a grid format. All maps can also be viewed in the Internet version of the tour guide system. The user can view and enlarge highlighted areas on the maps by simply clicking the mouse on the desired area of the map. From the selected enlarged map, the user can get access to tourist information on what is located within that area of the city. There is a list of categories of tourist information accessible through the tour guide map. For example, the categories in which the user can search for information on tourist sites, hotels, restaurants, entertainment venues, embassies, special event venues and historic sites amongst others. If the tourist wants to locate a hotel in the selected enlarged map area, they click on the hotel of interest and the hotel's name, address, phone number and other information provided within the advertiser's profile will appear on the screen. While the user is in any of the grids for any of the featured cities they can also access information related to the other tourist information within the tour guide system.

### PLAN YOUR TRIP

The tour guide system allows the user either 1) an opportunity for the tour guide system to plan their trip or 2) allows the user to plan their own trip and daily activities. The user inputs certain time and trip preferences into the present invention system and the system program software creates an itinerary according to the specific desires of the user. For example, if the user wants to visit three cities and see historic sites during a two-week period, then the results of the tour guide program will automatically create and save an itinerary that includes the preselected places that the user gave. The planned trip itinerary will include addresses of selected venues, times of special events, location of businesses advertised with the service provider, transportation and travel times between venues and other information within the parameters chosen by the user.

### LANGUAGE LEARNING

The present invention allows the user to learn a foreign language or English by accessing the language learning system, through the Product Line on the homepage of service provider. The teaching method of the language learning system helps users learn at different levels of language competency to study at their own pace, comfortably learning the target foreign language. By using the language learning system, the user develops more than core communication skills, he is also exposed to cultural mores and business etiquette.

The preferred embodiment of the present invention, the language learning component teaches the user, Chinese. In alternative embodiments, the language learning component of the present invention can be used to teach the user other foreign languages, including Arabic, Farsi, French, German, Hindi, Japanese, Korean, Portuguese, Russian, Spanish, and Swahili, as well as English.

The language learning system maximizes the language learning experience with program highlights and places emphasis on four linguistic methods—visual, auditory, speech replication and tactical—to make language learning easy and enjoyable by using multimedia formats. The preferred embodiment teaches a Chinese language component of the present invention that is comprised of three modules. The three modules are Speak Chinese, Read Chinese and Write Chinese. Each module has proven methods of instruction that allow the user to learn how to speak, read and write Chinese. Each module has two choices, 1) directs the user on how to use the module and 2) instructs the user on the actual lesson of the language learning system. Using each module according to suggested method will teach and allow the user to maintain a steady learning curve to improve and eventually perfect their speaking, reading, comprehension and writing the Chinese language.

Once the user understands how to use the tutorial, the user can go directly to language learning system and begin using the modules to learn Chinese.

Mandarin Chinese is taught in the language learning system of the preferred embodiment. In the speaking module, the user will see, for example, the four-tones in Mandarin Chinese, which instructs the user to understand the four tones of Mandarin-using English words or phrases to indicate what the four tones are, how to achieve those tones, and the number system used to indicate at which tone the Chinese word is spoken. Listening comprehension is improved through listening to repetitions of those sounds, which increases Chinese word recognition and improves listening comprehension. The user also improves their speaking by repeating orally the sounds presented, and it helps strengthen the user's mouth and memorization processes in the brain through pronunciation exercises. This methodology increases understanding and speaking ability as it relates to the skills needed to function in a Chinese speaking environment such as China or the local Chinese restaurant.

The other subjects in the language learning system include an explanation of 1) what Mandarin Chinese language is, how it is spoken and written, and the philosophy of learning Chinese as a useful tool to the tourist, 2) PIN YING:—which allows the user to understand linguistically, how to say the non-English sounds using the “Pin Ying” English transliteration format (most commonly used today in Chinese linguistics) and how to use linguistic applications to learn where in the mouth and how Chinese sounds are made. Sound making exercises are incorporated to assist the user pronounce the sounds necessary in learning how to speak Chinese.

The program continues to instruct the user with the Chinese Writing System, which instructs the user to understand the Chinese character writing system in association with Romanized letters to spell out words. The language learning system instructs the user on the stroke order system of writing Chinese characters. There is also an explanation on Chinese grammar rules and their association with English grammar rules.

The language learning system has a component allows the user to review what they have learned in each teaching methodology. There is an instructional training in each module to facilitate using the module. There are interactive tests that will further challenge the user. Depending on the responses of the user, there is a response that comes on the screen and an audio indicator that broadcasts “correct” or “incorrect” to the user.

Expanded service in additional embodiments of the present invention include, but are not limited to, other forms of content (e.g., expanded video and audio features, language learning features,) which will be additional advantages and novel features. The user can access the present invention at anytime by switching to their mobile technology whether outside their home or while on a trip to their chosen foreign language region. Additional advantages and novel features of the invention are set forth in the detailed description and in part will become more apparent to those skilled in the art upon examination of the following.

These and other features of the present invention will become readily apparent upon further review of the following specification and drawings.

### BRIEF DESCRIPTION OF THE DRAWINGS

FIG. 1 is a block diagram of a first embodiment of a web-enabled or CD-ROM-enabled tour guide system in accordance with the present invention as described.

FIG. 2 depicts the breakdown of the product line offerings.

Similar reference characters denote corresponding features consistently throughout the attached drawings.

### DETAILED DESCRIPTION OF THE PREFERRED EMBODIMENTS

The present invention relates to a system and method for enhancing the travel experience for tourists utilizing a multimedia system that incorporates various stationary and mobile electronic devices such as desktop computer, laptop computers, MP3/MP4 players, personal digital assistants (PDA), and conventional technology as it is developed.

The following description of the preferred embodiments is offered to enable one of ordinary skill in the art to make and use the invention as provided in the context of a particular application. Various modifications to the preferred embodiment will be evident to those with skill in the art. Moreover, the general principles defined herein may be applied to other embodiments. Therefore, the present invention is not intended to be limited to the particular embodiments shown and described, but is to be afforded the widest scope consistent with the principles and elements described herein.

The present invention can be used by tourists and business people alike to enhance their travel experience before, during, and after a trip. For example, prior to a trip, a user can access one of two levels of integral language learning components designed to facilitate cultural immersion. Moreover, a user can access necessary information to plan trips and view informative video clips of cities before setting out on their journeys to foreign countries. The present invention will allow the user get familiar with the cities on their itinerary, download the program into a home computer and a PDA, which allows accessible during the trip abroad. The preferred embodiment of the present invention will focus on tourist information for five major cities in China—Beijing, Shanghai, Hong Kong, Xian and Guilin. The present invention further features short commercials on local hotels, restaurants, and businesses of interest to tourist. The present invention also feature navigational maps to assist the tourist travel through the five-featured cities of the preferred embodiment. Alternatively, the invention can be adapted to immerse a user in a plurality of foreign locales (languages) including but not limited to France (French), Kenya (Swahili), Saudia Arabia (Arabic), Germany (German), Japan (Japanese), and Mexico (Spanish).

The present invention further features dual levels of the language learning system (“LLS”): a survival level for quick indoctrination and a native level for more comprehensive immersion. The LLS teaches a user how to speak, comprehend, read, and write Chinese words and sentence structures that will facilitate improved communication during the travel of the user. The language learning system has interactive, voice-enhanced, and visual methods of teaching the Chinese language that are screen-based and accompanied by audio inputs and interfaces. The language learning system also allows the user to learn, review and test their comprehensive understanding of the language so their ability to communicate is enhanced for their travel to China in the preferred embodiment.

The present invention is embodied in an electronic tour guide system downloaded from a tour-guide web site to a PC, PDA, or other electronic mobile device capable of displaying the screen-based multimedia components of the system. The user selects a city with a profile in the database of the tour guide system. Smart guide software, responsive to a request from the user, can create a customized tour program. The smart guide leads the user along the customized tour route by voice, video and/or graphics, and provides information about each entity on the tour. The interactive tour guide system responds like a human tour-guide to the needs of the user.

The downloaded interactive tour guide system provides a digital city map with interactive guided tours, theme guided tours, and allows for self-guided tours. The digital city map is also an interactive map that provides for a variety of overlaid information such as transit lines, restaurant locations, hotel accommodations and the like.

The present invention is also embodied in an electronic tour guide device and system enabled to access a global communication network, such as the Internet. The tour-guide system can be further embodied in a portable wireless device such as a cellular telephone or laptop computer with a cellular modem enabled to access a virtual tour-guide web site on the World Wide Web (WWW). The virtual tour guide web site is designed as a portal for the global tourism community to access the Internet.

The present virtual tour guide system may provide a directed tour and can personalize or customize a trip itinerary by taking the user's individual expressed preferences into account. A smart guide software module using data request/response software makes the present invented tour guide system a goal-directed and interactive virtual tour guide.

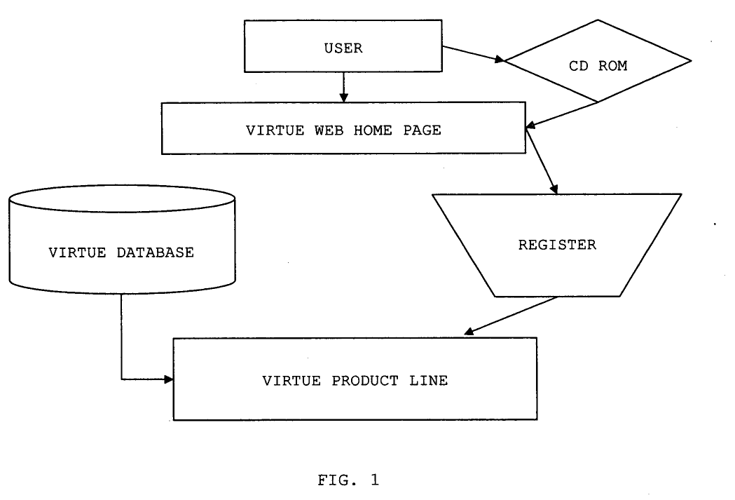

Virtue, according to the present invention is illustrated generally in FIG. 1. A user operates the software system, provided on CD-ROM, utilizing a desktop personal computer equipped for multimedia presentations. In the preferred embodiment, illustrated in FIG. 1A, the personal computer system includes a 286, 386, 486, or Pentium™ Intel™ processor or equivalent, with typical memory devices, associated circuitry and peripheral devices including a monitor or cathode ray tube (CRT), a speaker or audio system, a printer, a CD-ROM player, a mouse or similar pointing device, and keyboard. Alternatively, the software system can be provided on diskette, run from a hard drive or central server (e.g. a local area network internally linked to a mainframe or externally linked to the Internet).

VIRTUE includes city views of a targeted city both online and printed in an accompanying paper map book. VIRTUE features a travel planning feature that enables users to generate digital or hardcopy travel plans from routing operations and selected audio, text and pictorial information on hotels, restaurants, tourist attractions, and the like.

VIRTURE can be initially accessed by user two ways, First, the user can purchase a paper map book with an accompanying CD-ROM at a bookstore or wholesale venue. Using this option, the user places the CD-ROM in his or her computer and the CD-ROM interfaces with the service provider website to allow access to VIRTUE after the user completes the registration process. The second option entails the user going to the service provider website directly and using a credit or debit card to purchase access to VIRTURE. After payment is tendered, the user completes the registration process.

### Virture Map Book

Users can purchase a VIRTUE book package at bookstores, sporting events, new book conferences, or through company-sponsored sales presentations. Inside the book package is a VIRTUE map book and an accompanying CD-ROM that features a short promotional video. The purchased CD-ROM has tracking codes embedded therein that allow a user to register with the VIRTUE website, thereby gaining limited access to VIRTUE. The tracking codes provides the service provider with a method of tracking and determining whether the program was purchased at a retail venue or online. The tracking codes will not be made available to the user.

### Purchasing Virtue Online

Purchasing the present invention online is the preferred method of access. When a user purchases VIRTUE online, he or she must also register their personal information with the service provider and tender the appropriate payment depending on which services are desired by the user.

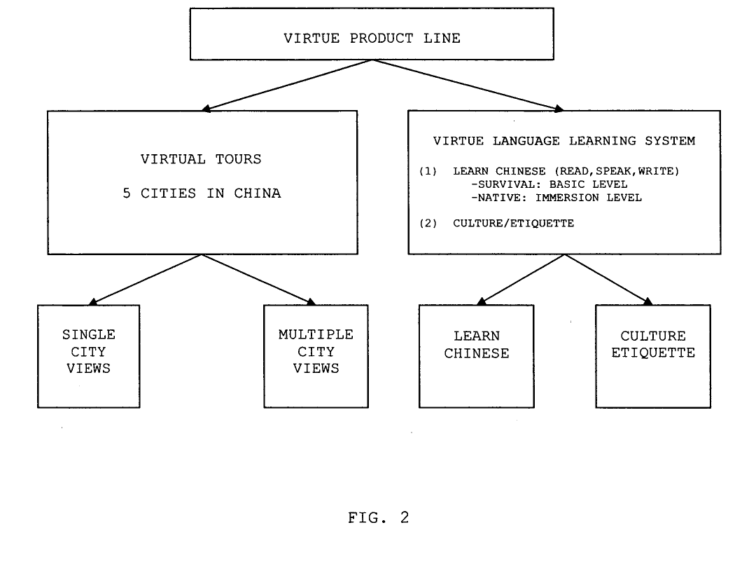

Referring to FIG. 2, once the payment has been verified, encoding provides the user access to the product lines they have purchased. The user can purchase either (a) VIRTUE: The Tour Guide and city views, which includes a cultural etiquette component—as a single city view or as many as five city views of the available cities currently in the present invention, or (b) The VIRTUE Chinese language learning system individually, or (c) Both VIRTUE: The Tour Guide/city views, which includes a cultural etiquette component, and the VIRTUE Chinese language learning system as a complete package.

After the purchase/registration phase is completed, the user enters the VIRTUE web site and is greeted with a short introductory video that provides a general overview of VIRTUE. Subsequently, the user is guided to a product line screen. From the product line screen, the user can select via a mouse device one of the various areas within the VIRTUE program for which the user has paid access.

Finally, the areas for visual tours are for each individual city only. Users will have limited access to one each or all available city views. If a user purchases full access to the tour guide system via the Virtue website, the user will be able to access the language learning system as well the city view components of VIRTUE.

### Registration

After a user purchases access to VIRTUE, via the map book/CD-ROM or online, the user will enter the registration site and complete the online form. The registration system will recognize the embedded codes on the CD-ROM for those users that purchase a map book. The CD-ROM codes notify the system that the user has purchased access to VIRTURE and Chinese LLS. The user will have to enter a personal password that is used in conjunction with the embedded codes within VIRTUE. When the personal password is entered and verified, the user can access paid features of VIRTUE. The personal information of the user is stored in the system database in conjunction with the CD-ROM codes, hence no other user can use that original code again. The original codes on the CD-ROM are archived for usage by the service provider to verify sales and other internal information associated with the user. The system automatically issues the user a new embedded code that will permit the user to use both VIRTUE and the Chinese LLS.

When the user goes from the registration form to the Product Line screen, depending upon the embedded code which allows one or more levels to be accessed at the VIRTUE website, the enbedded codes will either enable the user to gain access to the city views one time only, or multiple times, and/or the Chinese LLS.

For those users who have purchased multiple city views or the Chinese LLS, whenever the user returns to the online program, the codes will be matched. Hence, the codes issued when the user first registerd online must match the code embedded in the VIRTUE database. If the code does not match, the user is prevented from entering any of the VIRTUE programs. The user is only able to access the “Contact Us” webpage to seek assistance. It is appropriate to note that the user can get temporary access via the “Contact Us” webpage in certain instances, e.g. the user's PDA has been lost or stolen during travel and the downloaded version can not be accessed. The user will be issued a temporary password by the service provider that will be used to access stored user profile information so the user can access Virtue on the road. This remedy is temporary and access to VIRTUE will be time-sensitive. The number of systems downloads is determined by the service provider.

### Virtue City Views: Single or Multiple

When a user registers online for the first time, the registration system directs the user to the registration form. After the user has completed the registration form and verification of payment is received, the user is assigned an embedded code and issued a password that will permit the user to enter the area or areas for which the user has paid access.

The user has the option of paying for a single city view, multiple city views, or the LLS. The fees associated with each option or combination thereof are predetermined by the service provider. If, for instance, the user has previously purchased a package with multiple-city views package, the user can return to VIRTUE within a prescribed time period and purchase access to the full Chinese LLS at a discounted price set by the service provider.

If the user opts to purchase a single city view, the user is able to view only one city view and would not be able to view this information again after exiting the system. By purchasing multiple city views, the user is able to see multiple city views presently and in the future. The user can purchase a single or multiple city views in conjunction with the Chinese LLS, hence the user is able to see multiple city views and access the Chinese LLS.

### City View Purchases

When the user purchases either a single city view or multiple city views, the user will have access to the city views only. Whether the user has purchased a single city view or multiple city views, he or she will be able to access a selected city and view a video overview of that selected city. The user uses a mouse device to select one of the available city views from a menu of cities that includes, but is not limited to, Beijing, Shanghai, Hong Kong, Xian and Guilin. This selection prompts a video overview of that available city.

The overview is a video presentation that highlights points of interests and other information useful to tourists about the selected city. For example, if the user selects Beijing, a video is shown that highlights various attractions and offerings in Beijing, such as the 2008 Beijing Olympics. After the video is viewed, the user can either repeat the video or select another city view if the user has purchased the mulitiple city view option.

Within a particular city view, the user has the option of selecting one of several categories of interest about that city. Categories of interest would include, but are not limited to, hotels, restaurants, shopping, entertainment, travel (airports, train and bus stations, subway, etc.), tourist attractions, government agencies and embassies. For multiple city view purchasers, city updates will appear periodically as events approach or transpire within an available city. For instance, a user who has purchased multiple city views and interested in planning a trip for the 2008 Beijing Olympics would be able to view city updates detailing the progress of the Olympics games in affected cities that will appear periodically from September 2006 through the conclusion of Beijing games. Moreover, if the user has purchased multiple city views, he or she will be able to utilize the “Plan Your Activities” feature that will be discussed in detail later.

### Navigating the Website

Various business entities can contract with the service provider to be a featured business that is shown to the user when a user selects a category of interest for a particular city. No matter what level of access the user has purchased, the user can venture to the webpage dedicated to paid advertisers and search for featured advertisers via one of the applicable categories of interest. Additionally, multiple city view purchasers will be able to view featured advertiser within the city updates and “Plan Your Activities” areas.

Users will also be able purchase luggage, clothing and other items via a retail page available on VIRTUE. The website also features a “Frequently Asked Questions” (FAQs) page and a page dedicated to providing background information about the service provider and named principals. As mentioned earlier, a “Contact Us” page is provided that lists relevant telephone numbers and is constructed to allow users to send an emails to the service provider.

### Utilizing City Views

The user can access even deeper levels of information within a particular city view.

### Visual Tour

The visual tour is based on an overview of the most popular tourism spots within each city and the surrounding suburbs. The video will introduce them to very important sites and a general overview of what occurs in that city. For example, in Beijing, the visual tour will show the user Tiananmen Square, the Temple of Heaven, the Great Wall of China, etc. Moreover, the visual tour will broach various topics, such as shopping areas, transportation centers, government agencies, embassies, airports, etc.

For a particular tourist attraction, the visual tour will provide historical information about the tourist attraction—in addition to logistical information such as how to get there and what venues of interest, such as restaurants, or services are located nearby.

### How the Virtue: The Tour Guide Map Operates

The system offers digital maps for each available city that are uniquely constructed. On the digital map, the city is divided into grids, which highlight each section of the city. When the user goes to the digital city map, the user is able to click on any grid via a mouse device, which causes the selected grid to enlarge and show that section of the city in greater detail with a listing of relevant tourist sites and services in that particular grid. A digital city map features a series of equally spaced letters, beginning with the letter “A,” disposed vertically starting from the top to the bottom on the left side of the digital city map. Equally spaced numbers, beginning with the number “1,” are disposed horizontally from the left to the right across the top of the digital city map. Hence, the grid in the upper left hand corner of the digital city map is designated as “A1.” If inclined, the user is able to click on grid A1, thereby causing grid A1 to enlarge for ease of viewing and providing the user with a listing of relevant tourist sites and services in that particular grid. The digital city maps are also designed to allow a user to further enlarge a section within a particular grid. Moreover, the user has the ability to pan in eight compass directions within a particular grid.

In practice, a map of a country or region, such as China, initially appears. Using China as an example, selected cities in China will appear on the initial map of China. A user can click on a selected city in China and a digital city map appears having the aforemention grid format. The user can click on a particular grid to enlarge a particular portion of the city for ease of viewing. When the enlarged grid appears, a listing of tourist categories of interest within that particular grid appears on the left side of the screen. The user can click on a category of interest and a listing of entities in that particular grid relevant to the selected category of interest will appear. For example, HOTELS may be a category of interest that appears for a particular enlarged grid. The user can click on HOTELS and a listing of all the hotels in the service provider database for that particular grid will appear. Next, the user can click on a particular hotel on the list for detailed information about the hotel provided by the proprietors of hotel.

A digital city map provides a graphical interface and between the user and the interactive tour guide. A digital city map allows the entire city to fit into the limited space of the personal digital assistant or PC screen. The opening screen shows an overall map of the city, with individual districts presented schematically in a grid format, each shown in a different color and labeled by name. Tapping (i.e., clicking on) any of the individual districts opens a map for a distinct grid, in the same orientation as the overall map, and showing city blocks, streets and avenues, parks and open spaces, and about a number of sites that are places of interest to a tourist.

The user indicates an area of interest by clicking on the map. To aid in orientation, the grid name appears in the lower navigation panel, alongside “zoom in; and “zoom out; buttons which allow the user to survey a smaller or larger part the area.

Four arrow buttons on the top, bottom, left and right, corresponding to north, east, west, and south allow the user to navigate or “drag” the grid map in any direction.

A grid borderline indicates when a new grid area appears on the screen, and the grid name in the lower navigation panel automatically changes accordingly if the curser moves into that distinct grid.

The digital city map contains various controls to provide an overview, various scenes, and information about transit lines.

Various points of interest to tourists are indicated as “hot spots” (digital links or hyper links) on the digital city map. The clicking or tapping on any of the digital links will bring up an information box about the exhibit. In addition to a textual description of the exhibit and its history, the information box may contain a photograph or video of each exhibit as it exists in the present day, as well as a photograph of the exhibit as it existed in the past.

### City Links

Unlike the printed map book, the site descriptions in the tour guide system are cross-linked (hyperlinked) to each another in a digital interactive manner. Each district grid is described (by text, voice or video) through three or four related screens or panels. One screen provides an overall introduction to the district grid while the other screens describe notable aspects of the district grid's history, character, famous personalities, as well as many local services.

The texts of both the district overviews and the local exhibits contain certain terms, names, and phrases that are highlighted in blue; these are hyperlinked to other screens. Further desired information can be acquired by clicking on successive hyperlinks. Finally, a hyperlinked alphabetical index to all proper names of places, buildings, events, etc. allows users to search the tour guide system for any specific and pertinent city information.

### Customization

If the user has not indicated any preferences, Virtue can provide canned tours. However, if the user has previously indicated preferences, the suggested tours will reflect those preferences. For example, if the tourist has indicated no interest in art museums, then the suggested tours will skip over art museums. A large variety of smart tour guide responses may be modeled from the universe of the typical and likely behavior of an actual human tour guide. The interactive guidebook of the present invention is more akin to a human tour guide as compared to a printed guidebook.

If the user indicates an interest by tapping on a specific art museum outside of a predetermined tour route, the smart tour guide might be programmed to ask, “Would you like to see this art museum?” If the answer was yes, directions are provided thus departing from the originally configured tour. Then, after departure from the art museum, the smart guide tour guide might be programmed to ask, “Would you like to see other art museums?” In such manner, the smart guide tour guide modifies the preferences of the tourist by learning what the tourist likes and dislikes.

### Listings of Specific Areas of Interest

The following entities discussed under each category of interest are also distinguished on a digital city map using various icon indicia.

HOTELS—The system database provides a searchable listing of tourist entities, such as hotels, for available cities. For each hotel listed, the service provider database will be able to produce digital images of the hotel along with address and telephone information. Reviews of the hotel and associated amenities are also available for the edification of the user. Moreover, the system provides the user with a listing of other tourist sites and services within the vicinity of the hotel.

RESTAURANTS—The system provides a searchable listing of restaurants, bars, and like eating/drinking establishments that offer a wide variety of cuisines in available cities. These entities are designated by a unique icon on the digital city map that signifies the location of any such entities in a particular grid. Moreover, the system provides the user with a listing of other tourist sites and services within the vicinity of a particular restaurant.

SHOPPING—The system provides a searchable listing of various shopping venues for available cities. The listing tour guide will provide listings of various shopping venues of various pricing ranges. Advertisers that have contracted with the service provider will appear in the listing with detailed information. These entities are designated by a unique icon on the digital city map that signifies the location of any such entities in a particular grid. For an available city, the system will also provide a listing of well-known marketplaces where a user can purchase various types of items, such as silk, antiques, etc. Moreover, the system provides the user with a listing of other tourist sites and services within the vicinity of a particular shopping venue.

ENTERTAINMENT—The system provides a searchable listing of various entertainment venues, such as theaters, drinking establishments, dance halls, theme parks, etc. These entities are designated by a unique icon on the digital city map that signifies the location of any such entities in a particular grid. Moreover, the system provides the user with a listing of other tourist sites and services within the vicinity of a particular entertainment venue.

GOVERNMENT AGENCIES—The system provides a searchable listing of governmental and emergency institutions, such as embassies, governmental agencies, police stations, hospitals, etc. These entities are designated by a unique icon on the digital city map that signifies the location of any such entities in a particular grid. Moreover, the system provides the user with a listing of other tourist sites and services within the vicinity of a particular government agency.

TRANSPORTATION—The system provides a searchable listing of transportation centers for buses, trains, airports, and rental car agencies. These entities are designated by a unique icon on the digital city map that signifies the location of any such entities in a particular grid. Moreover, the system provides the user with a listing of other tourist sites and services within the vicinity of a particular transportation center.

The ability to see where particular entities are on a digital city map facilitates the planning of activities in advance of or during a vacation.

### Plan My Activities for Me or Plan Your Own Activities

VIRTUE provides a user with a means to plan his or her trip within an available city. Initially, Virtue prompts the user to answer questions that are compiled in a user profile. Based on the responses of the user, Virtue will either 1) automatically plan a trip for the user based on user-defined parameters, e.g., amount of time for trip and specific categories of interest listed; or (2) allow the user to plan his or her own trip using the same resources as the automatic planning option.

When the user selects the automated trip planning option, Virtue will provide the user with a list entities for each selected category of interests that is useful in planning a trip to an available destination. For example, if they want to see more historical tourist spots, the list will provide the user with the most popular tourist spots within the city. Once the user has selected the particular categories of interest, Virtue program will automatically create and save an itinerary which includes the preselected places that are given to the user. Hence, a user can click on an item of interest, such as a tourist hotspot, and Virtue will automatically place the item in the itinerary of the user.

Once a tentative itinerary is created, Virtue will provide the name (in two languages if applicable), address, and telephone number if applicable for each site or venue on the itinerary. The Virtue program will also provide an estimated travel time from each itinerary hotspot to the other utilizing various forms of transportation e.g., car or subway.

When the user has completed their itinerary, they will have an opportunity to click on play and the itinerary will be displayed for the user. This means that the users starting location is highlighted within the grid. The next place on itinerary is then highlighted within the grid. For example, the user has selected a particular restaurant in a different grid location across town. The location will be highlighted within the grid where it is located, with its particular advertisement that gives information about it. The itinerary will do the same thing for, each site listed within it, playing each item on the map grid for visual display. This helps the user understand how traveling to these various places within the city can be achieved via subway or car and anticipated travel times.

Additionally, the Virtue program will also highlight difficulties in travel time between selected categories. This means if a user inputs a six-hour time frame and the user has selected categories that would take eight hours to complete, the user will be notified that their itinerary exceeds the time limitations established by the user.

### Plan Your Own Activities

When the user utilizes the plan your own trip they are allowed to have more freedom in selecting and planning their daily activities. The user is able to select from the several categories within each grid and plan their own itinerary. This will permit the user wider access of the VIRTUE: The Tour Guide database.

The user selects the particular category in which they have an interest, the Virtue program will automatically save an itinerary which includes the preselected places the user selects. (This means while in the plan my trip for me category, the key user can click on the tourist hotspot and place it on their itinerary.)

After the user has laid out a potential trip, each place within the itinerary will have the name of the place, (both in Chinese and English), address, and telephone number of applicable locations. The Virtue program will also provide their usual travel time from each itinerary spot to the next utilizing various forms of transportation e.g., car or subway.

When the user has completed their itinerary, they will have an opportunity to click on play and the itinerary will be displayed. This means that the users starting location is highlighted within the grid. The next place on itinerary is then highlighted within the grid. The itinerary will do the same thing for, each item listed within it, playing each item on the map grid for visual display. This helps the user understand how traveling to these various places within the city can be achieved via subway or car and anticipated travel times.

Additionally, the Virtue program will also highlight difficulties in travel time between selected categories. This means if a user inputs a six-hour time frame and the user has selected categories that would take eight hours to complete, the user will be notified that their itinerary exceeds the time limitations established by the user.

Depending upon the type of device used for storage of the VIRTUE: The Tour Guide, the itinerary information will be available for the user through direct streaming, and they can keep their daily itinerary on their particular multimedia device. The user will be able to store a completed trip itinerary and keep that information for future use.

### Selecting Multiple City Views

If the customer wishes to continue to the next city, they will purchase the multi-city overview, the same information will be provided to them for each city that they choose to look at the five-minute video.

If the customer wishes to continue and wants to purchase the full VIRTUE Multiple city views, they can go back to the Registration site and upgrade to the 5-city views for an additional fee. The user will again go through a shortened registration and purchase a plan before they are given further access to the multiple city views.

If the user wants to purchase the full VIRTUE: The Tour Guide program and Chinese LLS, and they are within the 14-day time period, the user will get a slight discount off the total cost of the full program.

If the customer has purchased the full VIRTUE: The Tour Guide program, they will not only have full access to all the available city views for a foreign locale, but they will also have access to the learning system program.

### Map Book

VIRTUE: The Tour Guide's Map Book comes with the CD when VIRTUE is purchased offline. When VIRTUE is purchased online, a complimenty Map Book is sent to the online purchaser under separate cover to the address given on the registration form.

The Map Book consists of an overview of each city, with a grid overlay that has vertically numbers, and horizontally alphabet. Each grid will have a corresponding sheet behind the overview map. Within each grid section there will be two transparent overlays. Each transparency will have icons relating to eight categories which correspond with listing of businesses, agencies, et cetera recommended by VIRTUE for the tourists. Each grid will be an expanded/blown up version of a street map. The large size will allow the overlays to indicate the proximity of each business within that grid. (The grid will have on it, if applicable, subway color lines.)

### Advertisers

Service provider will sell advertising space on the service provider website to American and Chinese advertisers. Chinese advertisers are brought to us via our joint venture partners in China, and will have their names and their business(es) listed under the various categories as stated above, e.g., hotels, restaurants, et cetera.

Access to these Chinese advertisers can be accessed through several methods, for example, via location, name, category, et cetera. This will also be true for domestic advertisers in the US. This listing will also be included in the Map Book in an alphabetic order and by category in the back of the Map Book, and the business' pertinent information is provided in English and Chinese. All advertisers will be accessible online and listed in the Map Book in English and Chinese in alphabetical order by business categories, e.g., company name, address, telephone number.

### Language Learning System

As shown in FIG. 2, the electronic tour guide system features a language learning system (“LLS”) that has three modules: speaking, reading, and writing. In the preferred embodiment, the language learning system will teach a user to speak, read, and write Mandarin Chinese. The user can go directly to the language learning system page and begin using the various modules to learn Chinese. Unknown to the user, they are utilizing three different databases to actively learn to speak, read, and right Mandarin Chinese. The three databases are: a) a video animation database having animated characters, b) an audio database, and c) a text database having a dual language vocabulary database.

### Speaking Module

The user will be provided with screens that explain how to use the program and the components needed to utilize the speaking module having sound-generation capability in conjunction with speakers of the multimedia device a user employs to access the system. This will involve getting the user to understand the four tones of Mandarin-using English words or phrases to indicate what the tones are, how to achieve those tones, and the number system used to indicate at which tone the Chinese word is spoken. There will be tests that will challenge the user. The Review questions will require the user to select from several possibilities, whether it is sound and tone recognition, identifying the correct number to indicate the tone system, or the English meaning of word taught in a sample. If the user still does not understand the point being taught at that time, the user can click on ANSWER and a pop-up screen appears which contains the explanation giving the purpose of the question, the right response and why.

If testing sound and tone, the user will have to select from the Pin Yin, and decide which tone was spoken. If incorrect, a large red X comes on the screen. If correct, a large green check comes on the screen.

If testing the user's understanding of Chinese character stroke order, the user will have to select from the various strokes and the corresponding name give to the stroke shown. User selects from a list of possible answers. If incorrect, a large red X comes on the screen and the user may be prompted to submit another answer. If correct, a large green check comes on the screen. If the person wants to review that word, there is a button to select repeat question. The same type of testing is used in the reading module.

In the speaking and reading modules of the LLS, several screens allow the user to hear a target spoken in plurality of male voices, female voices, or children's voices for context and tone. The voice employed is selected randomly when the person listens to a component in that area. For example, if a user hears a sentence the first time spoken by a male voice in the medium range, the next time the user hears a voice for the same sentence, it will be a female voice in the upper range. The third time, the user would hear a male voice in the lower range. The fourth time, the user would hear a female voice in the lower range. It would be selected randomly by the program software so that the user is not hearing the same voice over and over again. This variation of voices helps the user become familiar with the possible range of voice levels and enhances their listening comprehension when they are in actual native speaking situations.

### Speak Chinese Module—Survival Level

This module is designed to a user that wants to learn how to order fish in a Chinese restaurant that does not have an English language menu. The user will how to pronounce certain Chinese sounds and will be able to recognize them and would know generally the Chinese character's pronunciation and its English or equivalent phrase meaning.

First, when the PLAY button on the screen is clicked, there is an introduction to the lesson and the first animated character comes to the screen. As the animated characters come to the screen, there is a corresponding audio sound which gives the correct pronunciation of the Chinese, and permits the user to hear the correct pronunciation of the Chinese character being presented.

When in the speaking module, a user can utilize an integrated digital recorder to record their voice digitally. The Virtue software would compare the user's digital voice pattern with the software's embedded digital voice pattern of the sentence recorded voice in the lesson. If the comparison is beyond acceptable sound parameters in relationship to the voice template, the user is prompted by the software to repeat the sentence pattern three times and another comparison is done. If the sentence is within acceptable sound parameters, then the software moves on to the next sentence pattern in that part of the lesson.

The testing module will test at each lesson level or it will test at the study and review level. This means a user can test their knowledge within a lesson, or they can test within a set of lessons at beginner, intermediate beginner or advanced beginner levels.

### Read Chinese

When reading module is selected, a user sees a screen and there will be two choices: a) a module explanation with an overview of Mandarin Chinese, or b) the user can begin the reading module. In a manner similar to the aforementioned speaking module, the user will be presented with instructional images on the screen and prompted to interact with language learning system to foster reading skills.

### Write Chinese

This module will teach the user how to apply the stroke order system of writing Chinese characters and associate the similarity to Romanized letters used to spell out words. There is also an explanation on Chinese grammar rules and their association with English grammar rules. There is a review and testing section.

At each point in the learning process, the user can return to the Start page of that section and select another lesson or subject matter and new lessons in those categories. Or the user can go back or advance forward from any place in the particular module they are in, meaning they can repeat things they have already done by reentering that aspect of the study module they are in. If they are in speaking practice, they can go to listening comprehension, or the testing mode. The user continues to have flexibility to move within the specific module they are studying.

### Chinese/English Vocabulary Database

When the user is within one of the three modules, the user can access the Chinese/English Vocabulary Database. To access the database, the user highlights and then clicks on a Chinese character presented for instructional purposes and an appropriate word card for that character will appear in a pop-up screen.

### Chinese Culture and Etiquette Database

The Chinese Culture and Etiquette Database has textual, pictorial, and multimedia materials that are listed by topic/subject area that relate to Chinese cultural aspects for tourists traveling in China. In some instances, there will be text and pictures and in other instances, there will be corresponding multimedia clips, which show how to respond to certain etiquette expectations or how to perform certain Chinese cultural gestures. The user will be able to read and hear explanations with step-by-step instructions for performing various cultural gestures. For example, a user will learn how to eat with chopsticks, how to perform a particular ritual at a temple, etc.

It is to be understood that the present invention is not limited to the embodiments described above, but encompasses any and all embodiments within the scope of the following claims.

We claim:

1. An electronic tour guide system, comprising: intelligent means for interfacing with a globlal communication network with a proprietary database containing geographic location-specific information and language learning means in a multimedia format downloadable to stationary and mobile communication terminals, the geographic location-specific information including tourist and business traveler information, the language learning means for basic survival language indoctrination, the language learning means for native language immersion.
